(19) United States
(12) Patent Application Publication
(10) Pub. No.: US 2024/0102557 A1
(43) Pub. Date: Mar. 28, 2024

(54) PACKING SEAL

(71) Applicant: CDI ENERGY PRODUCTS, LLC, Humble, TX (US)

(72) Inventors: Mehdi Hashemian, Kingwood, TX (US); Scott C. Schuette, Spring, TX (US); William Michael Hedger, Jr., Cleveland, TX (US); Juan Villegas, Humble, TX (US)

(21) Appl. No.: 18/475,993

(22) Filed: Sep. 27, 2023

Related U.S. Application Data
(60) Provisional application No. 63/377,232, filed on Sep. 27, 2022.

(51) Int. Cl. F16J 15/44

(52) U.S. Cl. CPC F16J 15/441

(57) ABSTRACT

A packing seal for a reciprocating pump includes a header ring. The header ring has an annular body with an inner surface and an outer surface. A plurality of inner wall segments is formed on at least one of the inner surface and the outer surface of the header ring.

### CROSS REFERENCE TO RELATED APPLICATIONS

This application claims the benefit of U.S. Provisional Application No. 63/377,232, filed on Sep. 27, 2022. The entire disclosure of the above application is hereby incorporated herein by reference.

### FIELD

The present invention relates to a seal and, more particularly, to a header ring and packing seal system for reciprocal pumps.

### BACKGROUND OF THE INVENTION

Hydraulic fracturing or “fracking” is a process employed for removal of petroleum, natural gas, coal seam gas and other flowable substances from beneath the earth's surface. Highly pressurized fluid is forced into a wellbore to create new fractures in a rock layer. After creating the fracture it is desirable to maintain the fracture width since this increases extraction rates and recovery of fossil fuels. Thus, material such as sand, ceramic, or other particulate, which is known as proppant, is mixed with the fluid and injected into the fracture to keep it open. The abrasiveness of particulates used in the material, however, wreaks havoc on piston/cylinder or plunger/bore assemblies, herein after referred to as “assemblies,” of the high-pressure pumps used in “fracking.”

For example, when the particulates are allowed between the walls of the assemblies, loss of pressure results. Keeping the particulates from reaching between the bore and plunger, therefore, is essential for seal duration. Well service packing (WSP) is typically used to seal gaps and permit slidable engagement between components within the assemblies. The well service packing is a collection of annular or ring-shaped seals contained in the bore, known in the art as a “stuffing box,” and arranged in a particular order so as to incrementally ride against the outer wall of the plunger and create a seal at a fluid end of the plunger. The bore receives the reciprocating plunger making replacement of all of the seals, which often must be done in the field, more manageable and convenient. The seals typically comprise a header ring at the fluid end and at least a pressure ring. The header ring is especially necessitated for providing a desired seal since it is adjacent the fluid end and absorbs and receives a greatest amount of wear and pressure.

Disadvantageously, in the field, the header rings are beginning to wear more rapidly and severely due to changing particle sizing of the proppant. Smaller proppant particle size preferred in fracking jobs has become increasingly smaller in size in order for the proppant to enter smaller fractures in the Earth's surface. Additionally, the seal has to withstand a range of different fluid hydrogen concentrations, pHs. For example, the pressurized fluid may be cement (mildly acidic) instead of water (neutral), for example. The material from which the seals are made, therefore, must be formed with desired physical properties. Known seals are made from elastomeric composites, which can be abrasive to the stuffing box even if there is no proppant between the seal and box. Furthermore, the seals are subjected between extreme ranges of both operating and non-operating low pressures and high pressures, elements, and chemicals. As a result, wear and tear of the seals are constant concerns.

Besides sealing issues resulting by not properly cleaning the contacting surfaces between the bore and plunger when replacing seals in the field, sealing problems are exacerbated by the mechanics of the stuffing box. Packing of the seal is secured in the stuffing box with a gland nut. If the nut is too tight, the header ring, which may be formed from a flexible material, can be extruded back into the fluid end which causes the seal to fail. Conversely, if the gland nut is too loose, the seal will repeatedly translate back and forth in the stuffing box causing wear and eventual failure of the seal. “Hammering” and damage to other components also results when the nut is too loose. Assuming the gland nut is properly secured initially, there is a possibility it may loosen subsequently due to vibration of the pump. As such, it is often difficult to develop a header ring that balances and maintains desired sealing effects with the unreliability of torque required for the gland nut in the field. As such, current header rings are desired to be more adequate to seal the fluid end of the wellbore.

Certain header rings include a singular inner lip to facilitate sealing against the plunger to properly filter proppants and fracking fluids. However, often the lip may become compromised due to wear and the unidirectional pulsating pressure on the inner surface of the header ring when the plunger moves toward the pressure end. Conversely, during retraction of the plunger, there is no significant pressure to bias the lip back to its original position to maintain the seal. Therefore, no elasticity of the lip is maintained to assure sealing. It may be difficult to obtain a lip geometry that improves robust sealing during a pressure stroke of the plunger and minimizes contact stress, friction, and wear of the lip geometry during an intake stroke of the plunger.

Another common issue is damage caused to an outer surface of the seal due to mating of the seal with the inner metal surface of the stuffing box. The header ring typically serves as the primary seal between the stuffing box and the plunger and causes wear to the metal surface of the stuffing box. Erosion of the metal surface due to the contact with the outer diameter of the header ring results in leakage. It is common to resurface the metal surface, apply spacers, or replace the metal surface.

Therefore, there remains a need for an improved packing seal system for a reciprocal pump including a header ring and backup ring with improved geometry and sealing.

### SUMMARY OF THE INVENTION

In accordance and attuned with the present invention, an improved packing seal system for a reciprocal pump including a header ring and backup ring with improved geometry and sealing features, has surprisingly been discovered.

According to an embodiment of the disclosure, a packing seal for a reciprocating pump is disclosed. The packing seal includes a header ring having an annular body with an inner surface and an outer surface. A plurality of inner wall segments are formed on at least one of the inner surface and the outer surface of the header ring.

According to another embodiment of the disclosure, a packing seal for a reciprocating pump is disclosed. The packing seal includes an annular header ring having a plurality of lips and a plurality of channels formed on an inner surface thereof. Each of the plurality of channels id formed adjacent to one of the plurality of lips. An annular backup ring directly engages the header ring.

### BRIEF DESCRIPTION OF THE DRAWINGS

The above advantages of the invention will become readily apparent to those skilled in the art from reading the following detailed description of an embodiment of the invention in the light of the accompanying drawings.

FIG. 1 is an elevational cross-sectional view of a header ring and a backup ring of a seal according to an embodiment of the disclosure;

FIG. 2 is a front perspective view of the header ring and the backup ring of the seal of FIG. 1, wherein a section thereof is partially removed; and

FIG. 3 is an elevational enlarged cutaway cross-sectional view of the header ring and the backup ring of the seal of FIGS. 1-2.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

A” and “an” as used herein indicate “at least one” of the item is present; a plurality of such items may be present, when possible. Spatially relative terms, such as “front,” “back,” “inner,” “outer,” “bottom,” “top,” “horizontal,” “vertical,” “upper,” “lower,” “side,” “above,” “below,” “beneath,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures.

As used herein, substantially is defined as “to a considerable degree” or “proximate” or as otherwise understood by one ordinarily skilled in the art or as otherwise noted. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Where any conflict or ambiguity may exist between a document incorporated by reference and this detailed description, the present detailed description controls. Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section.

The present technology relates to well service packing (WSP) technology employed in fracturing processes to remove petroleum, oil, natural gas, coal seam gas and other flowable substances from beneath the earth's surface. WSP is typically used to seal a gap between a bore and plunger of a reciprocating pump assembly and still maintain a slidable engagement between the bore and plunger. The packing is a collection of annular or ring-shaped seals contained in a bore, commonly known as a “stuffing box,” and arranged in order so as to incrementally ride against the wall of the plunger and seal it at the fluid end. Particularly, the present technology relates to a header ring and an adaptor ring or backup ring of the packing seal for the reciprocating pump. The header ring is typically positioned at the at or towards the fluid end of the reciprocating pump. It is understood the seal described herein can be employed with other applications as desired or with other technologies or processes other than fracturing processes and reciprocating pumps.

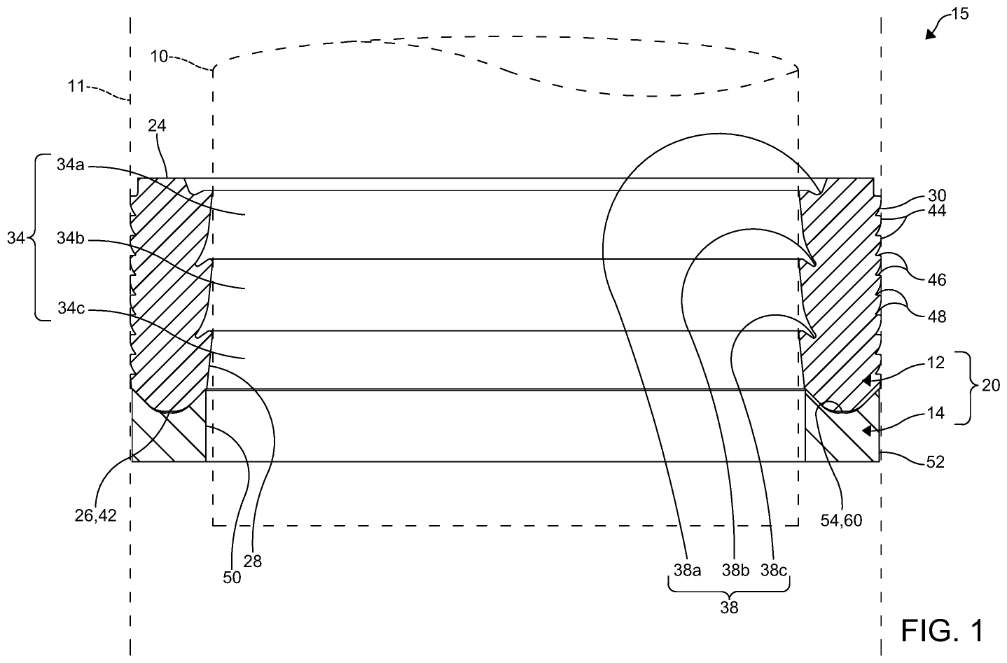

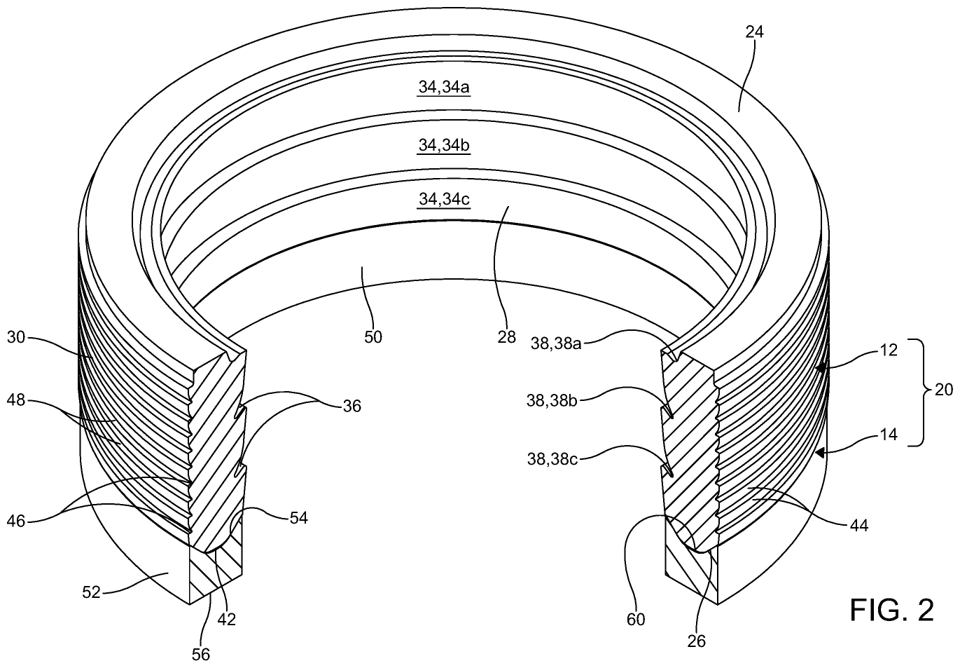

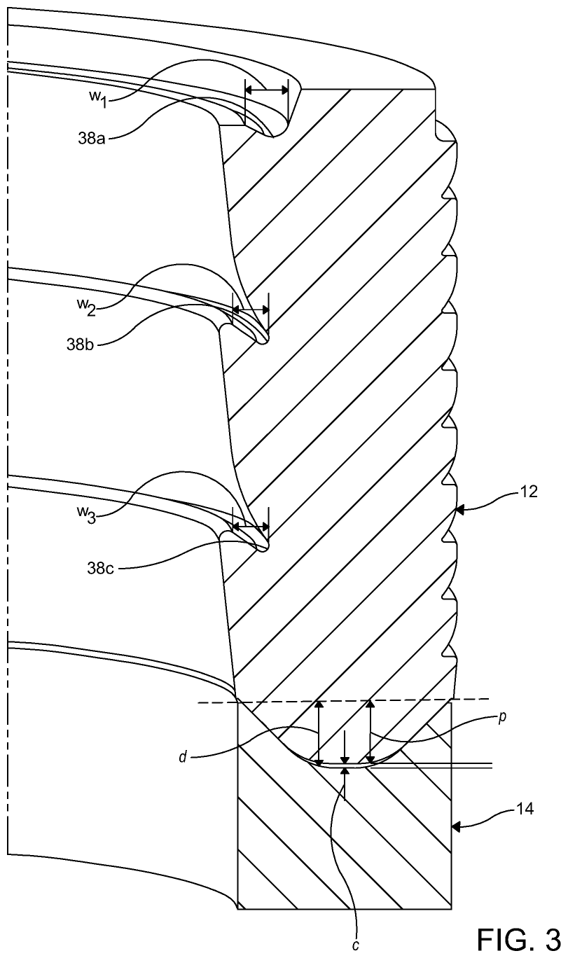

FIGS. 1-3 illustrate a seal 20 configured for a sealing system or packing set for a reciprocating pump. The seal 20 may include a series of sealing rings that make up a seal packing. In another embodiment, the seal 20 of the invention replaces a series of sealing rings. The seal 20 is annular and engages and receives a plunger or piston 10 (schematically represented phantom lines). The seal 20 is typically positioned between the plunger 10 and a stuffing box or bore 11 (schematically represented by phantom lines). Therefore, the seal 20 is configured for engaging the bore 11 on the outer surface of the seal 20 and the plunger 10 on an inner surface 28 of the seal 20. The seal 20 includes a header ring 12 and an adaptor ring or backup ring 14. It is understood, while not shown, the seal 20 can include other ring components such as a junk ring, a pressure ring, a seal cartridge, or additional one of any of the aforementioned.

The header ring 12 is annular and extends between a first substantially planar surface 24 and a second end surface 26 opposite the first end surface 24. The header ring 12 is generally positioned within the seal 20 proximate a fluid end (generally referenced by numeral 15). An inner surface 28 of the header ring 12 is configured as an inner ribbed wall formed from a plurality of annular ribbed inner wall segments 34. In the embodiment shown, the inner ribbed wall of the header ring 12 is divided into a first inner wall segment 34a, a second inner wall segment 34b, and a third inner wall segment 34c. However, it is understood the header ring 12 can include more than or fewer than three of the wall segments 34 if desired without departed from the scope of the present disclosure.

Each of the inner wall segments 34 have an arcuate cross-sectional profile, wherein the inner surface 28 at each of the inner wall segments 34 is substantially convex with respect to the inner surface 28 of the header ring 12 or bends towards an axial center of the seal 20. However, it is understood, the inner wall segments 34 can be concave with respect to the inner surface 28, if desired. In other examples, not shown, each of the inner wall segments 34 can have other profiles such as an undulating profile, rectilinear profile, tooth-like profile, varying profile, triangular profile, or a combination thereof, if desired.

Each of the inner wall segments 34 terminates at a cusp or lip 36. A plurality of inner wall channels 38 further define the inner wall segments 34. As illustrated, the plurality of channels 38 includes a first inner wall channel 38a, a second inner wall channel 38b, and a third inner wall channel 38c. However, it is understood more than or fewer than three of the inner wall channels 38 can be formed on the inner surface 28 of the header ring 12 depending on the number of the wall segments 34 required. Each of the channels 38 extend into the inner surface 28 of the header ring 12 and is formed at an angle with respect to an axial direction of the header ring 12. For example, the channels 38 extend at such an angle to position the lips 36, which are continuous with the respective channel 38, at about a 6 degree angle with respect to the axial direction of the header ring 12. However, other angles can be contemplated as desired. For example, the lips 36 can extend at an angle of about between 2 degrees and 8 degrees with respect to the axial direction of the header ring 12. It is necessary the lips 36 do not extend at too great of angle as to cause the lips 36 to fold or roll when the plunger 10 is retracting from the bore 11. The lips 36 are configured to bend towards the second end surface 26 of the header ring 12 when the plunger 10 is extracted from the bore 11.

As shown, the channels 38 extend into the inner surface 28 with respect to both a direction from the inner surface 28 of the header ring 12 to the an outer surface 30 of the header ring 12 and away from the first end surface 24 of the header ring 12. The first inner wall channel 38a has a width w₁ greater than a width w₂ of the second inner wall channel 38b and a width w₃ of the third inner wall channel 38c. The greater width w₁ of the first inner wall channel 38a, which is facing the fluid end 15 of the seal 20, facilitates a flexing of the first inner wall segment 34a as the plunger 10 engages the inner surface 28 of the header ring 12 as the plunger 10 extends and retracts so to maximize sealing. The greater width w₁ of the first inner wall channel 38a results in a greater biasing force from the first inner wall segment 34a closer to the fluid end 15. As the plunger 10 moves towards the fluid end 15 from an opposing end, biasing forces resulting from the second inner wall segment 34b and the third inner wall segment 34c are not as great, balancing a gradual and smooth translation of the plunger 10 towards the fluid end 15 and facilitating additional sealing beyond the first inner wall segment 34a. The channels 38 are configured as a pocket to receive fluid and thus pressure to cause the lips 36 and the inner wall segments 34 to maximize sealing.

The profile of the inner wall segments 34 has resulted in particular advantageous results. Each of the inner wall segments 34 either slope or curve inwardly, with respect to an axial center of the header ring 12, towards the first end surface 24.

The outer surface 30 of the header ring 12 includes a plurality of ribbed outer wall segments 44, having a sawtooth cross-sectional shape. In the embodiment illustrated, nine of the outer wall segments 44 are shown. However, more than or fewer than nine of the outer wall segments 44 can be included on the outer surface 30, if desired. Each of the outer wall segments 44 terminates at a lip 46 defined by a plurality of channels 48. The profile of the outer wall segments 44 has resulted in particular advantageous results. Each of the outer wall segments 44 curve outwardly, with respect to the outer surface 30 of the header ring 12, towards the first end surface 24. The sawtooth cross-sectional shape, as shown, illustrates asymmetrical teeth having a moderate curved slope on one side of the teeth and a steep slope on the other side of the teeth.

The second end surface 26 of the header ring 12 includes an annular nipple 42 having an arcuate surface configured to engage with the backup ring 14. The nipple 42 has a substantially frustoconical with filleted corners cross-sectional shape having a substantially parabolic or bell-shape profile. However, it is understood, the cross-sectional shape and profile of the nipple 42 can be any cross-sectional shape, as desired.

The header ring 12 is monolithically formed. Although, in other embodiments, features of the header ring 12 can be separately formed and coupled. For example, each portion of the header ring 12 including one of the inner wall segments 34 can be separately formed and coupled together in a separate coupling application. The header ring 12 is formed from an abrasion resistant material such as thermoplastic polyurethane (TPU) or other polyurethane, carboxylated nitrile (XNBR), hydrogenated nitrile butadiene rubber (HNBR), fluoroelastomer (FKM), or urethane. Although, it is understood other abrasion resistant materials can be employed without departing from the scope of the disclosure.

The backup ring 14 directly engages the header ring 12 at the second end surface 26 of the header ring 12. The backup ring 14 is annular and includes an inner surface 50 and an outer surface 52 extending between a first end surface 54 and a second end surface 56 opposite the first end surface 54. An annular indentation 60 is formed in the first end surface 54 of the backup ring 14 for receiving the nipple 42 of the header ring 12. A clearance c is formed between the outer surface 30 of the header ring 12 at the nipple 42 and the inner surface 50 of the backup ring 14 at the indentation 60. The clearance c is formed due to a peak p of the nipple 42 of the header ring 12 being nominally less than a depth d of the indentation 60 of the backup ring 14. The clearance c permits nominal differences in dimensions, venting of pressure, wear of material, and movement of header ring 12 due to axial loading. The backup ring 14 is formed from a material such as polyetheretherketone (PEEK), polyphenylen sulfide (PPS), Or a combination thereof.

During operation, the plunger 10 moves in a direction (indicated by the arrow) from minimal pressure to the fluid end 15, which is the maximum pressure end. Therefore, as the plunger 10 extends into the bore 11, the pressure exerts upon the inner wall segments 34 and the outer wall segments 44. Specifically, forces exert upon the lips 36, 46 and channels 38, 48 of the wall segments 34, 44 and effect an outward biasing and flexing towards the respective one of the plunger 10 or bore 11 to create a seal there between. As a result, particulate is prevented from migrated between the plunger 10 and bore 11 and wear of the seal 20 is minimized. During retraction of the plunger 10 from the bore 11, because minimal pressure results, forces are not exerted on the wall segments 34, 44 and specifically the lips 36, 46 and the channels 38, 48. As a result, the wall segments 34, 44 are not pressed or apply a minimal force against the respective one of the plunger 10 or the bore 11 and thus the plunger 10 can be easily and smoothly retracted without a rolling or folding of the lips 36, 46. Additionally, the lips 36, 46 facilitate a “wiping” or shearing of the plunger 10 from the particulates thereon upon the extraction of the plunger 10 from the bore 11.

Advantageously, the seal 20 of the present disclosure results in a drop of unnecessary radial pressure against the plunger 10 during intake plunger stroke, which reduces friction and wear. Known seals often employ components, materials, or thicknesses that exert undesired radial pressure upon the plunger compared to the seal 20 of the present disclosure. As a result of minimized radial pressure, a life of the seal 20 is maximized. Due to the redundancy in the wall segments 34, 44 and the lips 36, 46, should one of the wall segments 34, 44 or lips 36, 46 fail, the next consecutive one of the wall segments 34, 44 or the lips 36, 46 perform the sealing function. Additionally, the seal 20 distributes radial pressure more evenly.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A packing seal for a reciprocating pump comprising:
a header ring having an annular body with an inner surface and an outer surface; and
a plurality of wall segments formed on at least one of the inner surface and the outer surface of the header ring.

2. The packing seal of claim 2, wherein the plurality of wall segments is formed on the inner surface.

3. The packing seal of claim 2, wherein each of the plurality of wall segments has an arcuate profile.

4. The packing seal of claim 2, wherein each of the plurality of wall segments has a lip formed thereon.

5. The packing seal of claim 2, wherein the header ring includes at least three of the plurality of wall segments.

6. The packing seal of claim 1, wherein a plurality of channels are formed on the inner surface of the header ring interposed between the plurality of wall segments.

7. The packing seal of claim 1, wherein the header ring includes a first end surface and a second end surface opposite the first end surface, and wherein a nipple is formed at the second end surface.

8. The packing seal of claim 7, wherein the nipple has a substantially parabolic cross-sectional profile.

9. The packing seal of claim 1, wherein the plurality of wall segments are formed on the outer surface of the header ring and have a sawtooth cross-sectional shape.

10. The packing seal of claim 1, wherein the header ring is formed from a thermoplastic polyurethane material.

11. The packing seal of claim 1, wherein the header ring is formed from a carboxylated nitrile material.

12. The packing seal of claim 1, wherein the header ring is formed from one of a hydrogenated nitrile butadiene rubber material, fluoroelastomer material, or a urethane material.

13. The packing seal of claim 1, wherein the packing seal includes a backup ring engaging the header seal, wherein the backup ring includes an indentation formed in a first end surface thereof engaging the header seal.

14. The packing seal of claim 13, wherein the backup ring is formed from at least one of a polyetheretherketone material and polyphenylen sulfide material.

15. A packing seal for a reciprocating pump comprising:
an annular header ring having a plurality of lips and a plurality of channels formed on an inner surface thereof, each of the plurality of channels formed adjacent to one of the plurality of lips; and
an annular backup ring directly engaging the header ring.

16. The packing seal of claim 15, wherein each of the plurality of lips extends at an angle between about 2 degrees and 8 degrees with respect to an axial direction of the header ring.

17. The packing seal of claim 16, wherein each of the plurality of lips extends at an angle of about 6 degrees.

18. The packing seal of claim 15, wherein each of the plurality of lips bend upon a pressure applied thereto.

19. The packing seal of claim 15, wherein the header ring includes a plurality of lips formed on an outer surface thereof and a plurality of channels interposed between the plurality of lips.

20. The packing seal of claim 19, wherein the header ring is formed at least one of a thermoplastic polyurethane material, a carboxylated nitrile material, a hydrogenated nitrile butadiene rubber material, a fluoroelastomer material, or a urethane material, and wherein the backup ring is formed from at least one of a polyetheretherketone material and polyphenylen sulfide material.
